(19) United States
(12) Patent Application Publication
(10) Pub. No.: US 2005/0196604 A1
(43) Pub. Date: Sep. 8, 2005

(54) Metallization process and product produced thereby

(75) Inventors: Joseph Funicelli, Totowa, NJ (US); Robert Gallino, Englewood Cliffs, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Unifoil Corporation, Fairfield, NJ (US)

(21) Appl. No.: 10/794,382

(22) Filed: Mar. 5, 2004

(51) Int. Cl. B32B 15/08; B44C 1/00

(52) U.S. Cl. 428/323; 428/336; 428/458; 427/458

(57) ABSTRACT

A layered structure produced by metallizing a substrate including: (a) providing a transfer film including film layer and metal layer bonded together by a cured breakaway layer; (b) providing a substrate; (c) applying electron beam curable transfer adhesive to a portion of the substrate; (d) securing the transfer film to the substrate, where the transfer adhesive is between the metal layer and substrate, forming an intermediate product; (e) passing the intermediate product through an electron beam curing apparatus to cure the transfer adhesive; and (f) removing the transfer film. In the metallized product, the cured breakaway coating is bonded only to the metal. The cured breakaway layer preferably has a cured elongation at break, in tension, of less than about 20%. Precise metallized edges are produced, e.g., edge variation of about ±0.010 in., or better. The process can be utilized with total or selective metal transfer.

### BACKGROUND OF THE INVENTION

The present invention relates generally to the metallization of a substrate utilizing a transfer film, either in a selective or non-selective metallization process. More particularly, the present invention relates to such metallization processes, which include a protective coating over the metallized substrate during the metallization step, rather than as a separate procedure. Aspects of the invention also focus on an intermediate product formed from a transfer film, coating, e.g., a cured coating, and metal layer used in the transfer process. Additionally, the present invention relates to the resulting metallized substrate.

Processes for the metallization of various substrates have been known for some time. These methods are typically a two-step process. The first step is to create a transfer mechanism. The transfer mechanism typically comprises a transfer film, or carrier, coated with a lacquer release layer. Metallic particles are then deposited onto the lacquer release layer by conventional methods such as vacuum deposition. In the second step, adhesive material is applied to a substrate whereupon the transfer mechanism is adhered, with the metallic layer adjacent the adhesive coating. After heating the various elements, the carrier layer is removed to reveal a metallic-coated substrate having a lacquered protective layer. In conventional terms, this process is known in the art as “hot stamping.” While hot stamping is beneficial for some uses, it only enjoys limited applicability.

Hot stamping may not be used with all substrates, as the heating process may be destructive. Also, it has been found that the hot stamped foil may separate from the substrate under aggressive conditions, if not under normal use. Such separation is undesirable as it compromises the integrity of the finished product. Hot stamped metallic foils are also not printable.

U.S. Pat. No. 4,473,422 (H. Parker et al., issued Sep. 25, 1984) discloses more advanced techniques for metallizing a substrate have subsequently been developed and are generally known in the art. One such method is to provide a transfer film having a coating layer and metallic layer on the film much like that of the hot stamping process. This three-part transfer film may then be adhered to a substrate using a pressure sensitive adhesive. Once the adhesive is cured, the film may be removed to reveal a substrate/adhesive/metal/coating product. For purposes of the present invention, the designation a/b/c/d, etc., is used to describe various products, structures or constructions where “a” is the base layer and “b,” “c,” “d,” etc. are successive layers of materials. Techniques of this type do not disclose the use of a 100% solids-containing, electron beam (EB) curable adhesive. As such, the substrate must be porous to permit a means of escape for the moisture or diluent contained in the uncured adhesive. In addition, this technique does not permit the selective metallization, or metallization in discontinuous regions, of the substrate. Rather, the metallization process must be conducted in a continuous sheet.

Other processes for nonselectively metallizing a substrate are also known. In one of these processes, U.S. Pat. No. 4,490,409 (S. Nablo, issued Dec. 25, 1984), a film is coated with a release coat adhesive and a prime coat protective coating. A metal layer is adhered to an electron beam radiation sensitive substrate, e.g., paper, with an adhesive. The various adhesive and the coating layers may be EB curable. When the film is removed after curing the release coat adhesive, prime coat protective coating, and metal layer adhesive, the release coat adhesive remains adhered to the film, leaving the prime coat protective coating as a layer above the metal. The final result is a substrate/adhesive/metal layer/protective coating system.

Processes for the selective metallization of a substrate are also known. One such process, U.S. Pat. No. 6,544,369 (Y. Kitamura et al., issued Apr. 8, 2003), utilizes a two-part transfer film in its first step. The two-part transfer film comprises metal deposited directly onto a plastic film using conventional methods. No coating layer or prime coat is adhered to the transfer film between the metal and the plastic film. A substrate is then introduced. Either the substrate or the metal side of the transfer film is selectively coated with an EB-curable adhesive. The substrate and the transfer film are then brought together and the adhesive is EB cured. The plastic film is then removed. The finished product is a substrate/adhesive/metal product. Of note, the metal layer of structures resulting from techniques of this type is exposed to the atmosphere, and not protected by a separate coating. Methods to improve this result are disclosed in the same reference.

One such method is to coat the metal in a completely separate second process. In this process, a curable resin of a solvent type, aqueous type, and water soluble type, is described and may be applied to a transfer film. This two-part film may then be covered over the substrate/adhesive/metal product of the prior technique. Once the resin is cured, removal of the film reveals a protected, selectively metallized substrate. Although the selectively metallized substrate is protected, the protection covers the entire substrate and not merely the selectively metallized portion. This presents limitations, as the areas which are not metallized, but which are protected, may suffer from undesired effects, such as reduced sharpness or color brightness, among others.

Notwithstanding these teachings, it would be advantageous to provide for the selective metallization of a substrate where the finished product comprises a substrate/adhesive/metal/coating system in a one-step process, particularly wherein the transfer film mechanism has been cured prior to curing of the adhesive. Furthermore, it would be desirable to produce a metallized structure in which the metallized portions, whether total or selective, have a well-defined, e.g., sharp or precise, separation from the non-metallized portions.

### SUMMARY OF THE INVENTION

An embodiment of the invention provides a layered structure comprising at least one each of: (a) a substrate layer; (b) a metal-containing layer; (c) an adhesive-containing layer adhering said metal in said metal-containing layer to said substrate layer; and (d) a breakaway layer, having a top surface and a bottom surface, said bottom surface of said breakaway layer coating substantially only said metal of said metal-containing layer. A further embodiment provides a metallized structure having selectively metallized areas. In accordance with one embodiment of the invention, there is disclosed a layered structure comprising at least one each of: (a) a substrate layer; (b) a metal-containing layer; (c) an adhesive-containing layer adhering said metal in said metal-containing layer to said substrate layer; and (d) a breakaway layer, having a top surface and a bottom surface, said bottom surface of said breakaway layer coating substantially only said metal of said metal-containing layer. In another embodiment the breakaway layer has a cured elongation at break when tested in tension of less than about 20%.

In yet another embodiment there is provided a method of metallizing a substrate comprising the steps of: (a) providing a transfer film comprising a film layer and a metal layer bonded together by a cured breakaway layer; (b) providing a substrate; (c) applying an electron beam curable transfer adhesive to at least a portion of said substrate; (d) securing said transfer film to said substrate comprising said transfer adhesive such that said transfer adhesive is disposed between said metal layer and said substrate to form an intermediate product; (e) passing said intermediate product through an electron beam curing apparatus to cure said transfer adhesive; (f) removing said transfer film from said intermediate product to provide a metallized substrate product having a cured breakaway layer bonded to said metal layer at said transfer adhesive portion. In a still further embodiment, there is disclosed a method of metallizing a substrate wherein the cured breakaway layer has a cured elongation at break when tested in tension of less than about 20%.

In other embodiments the structure is either totally or selectively metallized. The invention provides for structures having precise or sharp metallized edges, e.g., a metallized edge varies from a line drawn along the edge and mid-way through the variations from the line by less than or equal to about ±0.010 inches.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a cross-sectional view of a transfer film in accordance with a preferred embodiment of the present invention;

FIG. 2 is a cross-sectional view of an intermediate product in accordance with a preferred embodiment of the present invention;

FIG. 3 is a cross-sectional view of a selectively metallized substrate in accordance with a preferred embodiment of the present invention; and,

FIG. 4 is a schematic view of a method of selectively metallizing a substrate in accordance with a preferred embodiment of the present invention.

### DETAILED DESCRIPTION

In describing preferred embodiments of the subject matter illustrated and to be described with respect to the drawings, specific terminology will be resorted to for the sake of clarity. However, the invention is not intended to be limited to the specific terms so selected and it is to be understood that each specific term includes all technical equivalents which operate in a similar manner to accomplish a similar purpose.

In this regard, the term “film” or “carrier” shall broadly be construed as a thin and flexible sheet. The films utilized must have qualities such that a desired breakaway coating or layer of the invention adheres to the film, but that the affinity of the coating for the film is less than that of the breakaway coating's affinity for metal deposited on the breakaway coating. Suitable materials for the film or carrier include acetate; cellophane; polypropylene; polyethylene; polyester; polystyrene; holographic or diffraction films; clear, dyed, filled or coated films; mat finished films; metallized, full or patterned films; microwave and susceptor film; and treated film such as corona or chemically treated film. Mixtures of polymers having film-forming properties can also be used. Other than the suitable adhesion and release qualities as just described, the carrier film properties are not critical to the final construction or structure since the carrier film will not be an integral part thereof.

Useful film typically has a thickness of about 0.18 mil to about 4.0 mil; for example, from about 0.25 mil to about 2.5 mil; alternatively, about 0.5 mil to about 1.5 mil. If desired, the film may be dyed or colored with suitable materials. The film may also be embossed or patterned to produce a further surface effect on the final product.

As used herein, the term “coating” or “breakaway coating” is defined as at least one layer that is between the (carrier) film and a metal layer. The breakaway coating functions as an adhesive layer in that, in addition to other properties and characteristics described herein, including acting as a protective layer and as a printable layer, it adheres to the metal layer and, at least temporarily, to the carrier film layer. As a consequence of the process of the invention used to form the metallized structure, the metal present in the metal layer can be in the form of contiguous metal-containing areas or areas separated by non-metallized areas; in each instance, the breakaway coating is present only on the metallized portions of the metal-containing layer. Furthermore, it will be appreciated that the breakaway coating layer may be formed of either a single layer of material or of multiple layers of material. Such multiple layers may be of the same composition or may vary in composition from each other. In an alternative embodiment, the coating layer comprises at least two layers. Application of a second, and subsequent, layer can be employed to cover pinholes, or localized areas where coverage of the initial layer is considered to be inadequate. The composition of the breakaway coating layer used in the present invention generally comprises acrylates; urethane acrylates; epoxy acrylates; polyester acrylates; acrylate acrylics and other oligomers and polymers having suitable properties as further defined herein. For purposes of the present invention, the terms oligomer and polymer have their standard or accepted meanings in the art. For example, an oligomer is understood to be a polymer molecule comprising only a few monomer units, e.g., dimer, trimer, tetramer, etc., but can include as many as ten, twenty or more units since a precise upper limit is not fixed.

For purposes of the present invention, the breakaway coating must release from the carrier film and adhere to the metal present in the metal-containing layer in those areas in which the metal of the metal-containing layer is adhered via the transfer adhesive to the final product substrate. Release from the carrier film can be measured using, for example, an Instron® tester using a 6 inch long by 1 inch wide test strip of the carrier film to which a layer of the breakaway coating has been applied. A piece of #600, 3M Scotch Brand tape is tightly adhered to the coating layer and a free end of the tape is held in one jaw of the tester while the coated film is held in the other jaw. As the jaws are separated at a rate of 1 ft./min., the force required to pull the coating layer off of the film is measured. Typically, the breakaway coating will exhibit a maximum release strength of less than about 30 grams/inch; preferably about 2.0 to about 25.0 grams/inch; more preferably about 3.0 to about 15.0 grams/inch; most preferably about 3.5 to about 10.0 grams/inch; for example, about 3.5 to about 8.0 grams/inch.

In a particularly preferred embodiment of the invention, the breakaway coating exhibits a low level of elongation when stressed in tension. Consequently, the breakaway coating can be characterized as relatively rigid, tending to fracture under stress rather than exhibiting significant elongation. As will be further described in detail below, such fracture results in a desirable fine, precise or sharp, line of demarcation between the metallized and non-metallized areas due to the high adhesion of the metallized areas to the product substrate via the transfer adhesive. The elongation characteristic of the breakaway coating can be determined using a cured sample of the breakaway coating and following ASTM Method D882 for a material having a thickness of less than about 1.0 mm (0.04 in.) and ASTM Method D638-02a for any thickness up to about 14 mm (0.55 in.). Suitable test conditions are as follows: a test instrument such as an Instron tensile tester is used with the test sample mounted in the vertical direction; temperature, humidity, sample length, width and thickness should be selected and kept constant consistent with good laboratory test practices. Similarly, sample extension rate should be kept constant according to the test method, e.g., a suitable extension rate is about 0.1 to about 1 mm/min.; a convenient extension rate can be selected based on the properties of the particular breakaway composition. Separation of the test grips should be about 100 mm and the sample size at least 50 mm longer than the grip separation used; sample width can vary between about 5 mm and about 25 mm, but it should be at least 8 times the sample thickness. Sample preparation can conveniently be conducted using a smooth substrate that allows for good flow of the breakaway coating before it is fully cured, but low adhesion so that the coating is not distorted or fractured prior to testing. Suitable substrates or surfaces include smooth, polished mild steel and release paper such as silicone release paper. After the breakaway sample is fully cured according to the conditions suitable for the chemical composition of the coating, test samples can be die cut or cut from the cured composition using, e.g., a sharp knife or scalpel and a straight edge, e.g., a metal rule.

Suitable compositions for use as a breakaway coating in the present invention will have a cured elongation at break when tested in tension, as follows: (1) for use in selectively metallized structures, elongation at break that is typically about zero to less than about 20%; preferably about 0.5% to about 15%; more preferably about 0.75% to about 10%; for example, about 1% to about 8% or zero to about 8%. For purposes of the present invention, it should be understood that “zero” percent elongation includes values that are only slightly greater than zero and within experimental error of zero in view of the measuring capability of the test equipment used to measure this property. Consequently, if a sophisticated, high sensitivity instrument not typically used for general-purpose testing, would be capable of measuring an elongation value of about 0.4% to about 0.1% or lower, e.g., 0.01% or lower, such values are, for convenience, referred to herein as “zero.” Alternatively, such materials are characterized as brittle, in contrast to elastomeric or plastic, wherein elongation at break in tension for elastomeric or plastic compositions can be, e.g., about 100%, 150%, 200% or greater. (2) Breakaway layer compositions useful in metallized structures where the metal present in the metal-containing layer is substantially totally transferred, elongation at break that is typically about 100% to less than about 300%; preferably about 100% to about 200%; more preferably about 105% to about 175%; for example about 120%.

Useful oligomer and polymer compositions for the breakaway coating or layer of the present invention comprise at least one component selected from the group consisting of urethane acrylate resin; polyurethanes, including aliphatic and aromatic polyurethanes and mixtures; polyesters; cellulose derivatives, including cellulose acetate, cellulose acetate butyrate and nitrocellulose; acrylics; and mixtures thereof. The composition is preferably a urethane acrylate resin. The proportion of each component in, e.g., a urethane acrylate resin can be selected, with limited experimentation, in order to achieve usable as well as preferred elongation and release properties described above. For example, higher acrylate content would tend to have more adhesive characteristics and, if too high, could adhere unacceptably to the carrier film. Conversely, a higher level of urethane will more readily release from a polyester carrier film, but too high a urethane content may result in excessive elongation, depending on the character of the urethane selected and the type of metal transfer desired, i.e., selective or total. Given the property guidelines above, a broad range of oligomers and polymers can be selected for use in combination with the carrier film as well as the transfer adhesive layer and substrate, discussed hereinbelow.

The breakaway film, coating or layer is ordinarily applied as a liquid or fluid. The typical composition of the present invention can be applied as a water or solvent borne composition; useful solvents include methyl ethyl ketone, esters such as ethyl acetate and isopropyl acetate. Aliphatic solvents such as hexane or heptane and aromatics such as benzene or toluene typically are not used. The breakaway coating undergoes curing, e.g., with or without the application of heat, in order to fully cure, for example, substantially fully cure, to a rigid or brittle material, as described above. The breakaway coating of the present invention is typically oven dried to effect cure; useful curing temperatures are about 100° F. to about 500° F.; preferably about 200° F. to about 400° F.; most preferably about 250° F. to about 350° F. Useful commercial materials for purposes of the present invention include Grancoat® 571, 1012 and 8520 (Grant Industries, Inc.) as well as Solucote® 1091, an aliphatic polyurethane, water borne dispersion (Soluol Chemical Co., Inc.). It may also be suitable to employ a urethane acrylate or other oligomer/reactive diluent resin composition that is susceptible to radiation curing, e.g., using electron beam (EB) radiation curing, provided that the above-described suitable elongation and carrier release properties can be obtained. Furthermore, depending on the properties desired and the esthetic characteristics of the resulting structure, there can be incorporated into the breakaway layer additional materials, including fillers, dyes and pigments.

When the breakaway coating is applied to the underlying metal-containing metal layer, and when the final product structure is produced, including the substrate and transfer adhesive, the top surface of the breakaway layer of the present invention has a desirable surface finish as a consequence of using the materials and obtaining the properties as taught herein. Various surface finishes can be achieved, including a mirror finish, a matte finish, a hairline pattern finish, an embossed pattern finish, a hologram pattern finish and mixtures or combinations of these finishes.

As used herein, the term “transfer adhesive,” means a component, composition or material applied as a layer between the substrate and the metal-containing metal layer in order to secure or bond the substrate and metal layers to one another. Typical transfer adhesives comprise at least one component selected from the group consisting of urethane acrylate resin; epoxy acrylate resin; polyester acrylate resin; mono- di-, tri-, or tetra-hexacrylate resin; and mixtures thereof. Preferably, the transfer adhesive comprises a urethane acrylate resin; more preferably the transfer adhesive, including a urethane acrylate resin, is radiation curable, preferably using electron beam (EB) radiation. Electron beam radiation units useful in the present invention are readily available and typically consist of a transformer capable of stepping up line voltage to the required levels and an electron accelerator. The EB radiation initiates the formation of radicals or cations, sometimes enhanced by the use of initiators and other additives known in the art. The result is that the oligomers or polymers susceptible to radiation curing undergo cure. For purposes of the present invention the term “cure” is used with reference to oligomers, polymers, resins, adhesives, etc., useful in the present invention that can be thermally cured as well as those that can be cured by EB methods. Furthermore, for purposes of the present invention, “cure” means that such oligomers, polymers, and/or other materials referred to above or hereinafter, solidify, dry, set, harden, polymerize and/or crosslink, as is appropriate for the material employed. The term “full cure” or “fully cured” does not require, e.g., that the oligomer, polymer or resin, cure to the extent that no further curing reactions are possible, but merely to the point of practical utility; i.e., that the oligomer, polymer or resin has reached a condition where its physical properties are useful for the purposes intended herein. Alternatively, regarding materials that cure or set by drying, typically thermally assisted drying, the curing process removes a diluent or solvent present in the composition in order to effect the desired increased strength and/or brittleness. Regarding polymers capable of being cured by crosslinking, such polymers typically are considered to be fully cured when they achieve approximately 90% of the maximum modulus or tensile strength that they would achieve if the curing process was allowed to continue. Reaction time for EB curing can be extremely fast, e.g., in as little as about 0.1 seconds to about 10 seconds; although other processing variables may dictate the use of particular cure times. Furthermore, a transfer adhesive can further include at least one additive selected from the group consisting of fillers, dyes and pigments. Such additives can find utility for modifying the processing or final properties of the adhesive composition and its performance in the layered structure.

Useful EB curable resins include those made by Akzo Nobel Resins under the brand name Actilane® and including aromatic urethane acrylates, aliphatic urethane acrylates, epoxy acrylates, and polyester acrylates having various degrees of functionality, e.g., difunctional, trifunctional, etc. Radiation curable epoxy and urethane acrylates are also available from Sartomer Company, Inc. under various “SR” grade designations. A useful publication reports the performance properties of a broad range of compositions from which suitable materials can be selected; see Urethane Acrylates: Expansion of Radiation Curable Epoxy Acrylate Coatings, H. C. Miller, presented at Radtech '89-Europe, Oct. 9-11, 1989. Compositions having elongation values ranging from about 5% to about 50% are illustrated. Also useful are EB curable adhesives manufactured by Sun Chemical Co., including, for example, Sun Chemical® 7573, an aromatic urethane acrylate copolymer having a 50/50 weight ratio of urethane to acrylate (Sun Chemical Corporation).

The metal layer, typically in the form of a foil, is deposited by conventional methods such as vapor deposition or vacuum metallization. For purposes of the present invention, the term “metal layer” means the layer of the structure containing metal since it is not necessary that the metal be present throughout the metal layer. Consequently, this layer is more accurately defined as a “metal-containing” layer since metal may be present throughout the layer or only in selected portions depending on the desired appearance of the resulting structure. The manner in which total or selective portions of the metal-containing layer are metallized is described in detail below. The term “metal” is defined in the usual manner as any of various opaque, fusible, ductile and typically lustrous substances that are good conductors of electricity and heat. Typical metals form salts with non-metals, basic oxides with oxygen, and alloys with one another. For purposes of the present invention, the term metal also includes the various alloys thereof. Thus, a substance comprising two or more metals or of a metal and a non-metal intimately united, usually by being fused together and dissolved or dispersed in each other when molten, shall also be included in the definition of a metal. The metal layer of the present invention includes at least one metal. Some examples of metals that may be utilized in this invention are aluminum, silver, gold, platinum, zinc, copper, nickel, tin, silicon, and alloys and mixtures thereof. Deposition of the metal layer is accomplished by methods well-known in the art, including, e.g., vacuum deposition, sputtering, etc.

The thickness of the metal layer can vary depending on the visual effect desired. For example, thickness typically varies from about 20 angstroms (Å) to about 1000 Å; alternatively, the thickness can be selected from the group consisting of about 30 Å to about 800 Å; about 40 Å to about 600 Å; about 50 Å to about 400 Å; about 55 Å to about 300 Å; about 60 Å to about 200 Å; and about 25 Å to about 150 Å. Useful metal coatings can also be obtained at thicknesses of about 100 Å to about 600 Å; alternatively, about 150 Å to about 500 Å; for example, about 125 Å to about 450 Å. Furthermore, useful thicknesses of the metal present in the metal layer can be defined according to the optical density of the deposited metal. Typically, optical density is greater than about 1.5 to about 1.8; for example, about 2.0 or more, e.g., 3.0 or more. As optical density of a metal layer increases, the light transmission through it decreases. For example, an industry standard relating to digital video or versatile discs, DVDs, typically made of polycarbonate coated with a metallic coating, known as DVD 10, typically has an optical density of between 2 and 3, equivalent to only 0.1 to 0.3% transmission. It is recognized that materials with an optical density greater than 1.5 can be challenging to photocure, e.g., using UV curing. See, Published U.S. Application 2002/0066528, incorporated herein by reference in its entirety. Generally, the thickness of a metal layer can be determined, e.g., using an electron microscope or with surface resistivity measurements. The literature provides an estimate of the relationship between optical density of a metal film and its thickness, for example with regard to an aluminum film. Based on data for an aluminum layer exhibiting a surface resistance of 0.80 to 1.80 ohms per square and the relationship between film thickness and surface resistivity, the thickness of such a layer deposited at an optical density of 2 is estimated to range from 147 Å to 331 Å. See E. Mount, Converting Magazine, September 2002; and Section 2: “Electrical, Optical and Metal Thickness Relationships,” Metallizing Technical Reference, 3^{rd} Ed., E. M. Mount III Editor, Assn. of Industrial Metallizers, Coaters and Laminators, 2001; each reference incorporated herein in its entirety. The present invention is not limited to exceptionally thin metal layer thicknesses since curing of the breakaway layer and the adhesive-containing layer is preferably accomplished by, e.g., drying, thermal and electron beam curing methods, as described below in detail. In contrast, in order to use UV curing to cure compositions useful in, e.g., the breakaway and/or adhesive-containing layer, a very thin layer of metal is required in order to permit a sufficient amount of UV radiation to penetrate the metal layer and effect cure. Consequently, while the present invention excludes the use of UV radiation curing and its inherent limitations, the invention can advantageously use EB curing as well as utilize appropriate metal and breakaway layer thicknesses required for a particular application.

For purposes of the present invention, the term “substrate” means any underlying layer that forms the final product, structure or construction comprising the several layers described above. Typically, this underlying layer will be the base layer of the finished product. However, this need not be the case if other arrangements are desired. The substrate can be produced in a form selected from the group consisting of board, sheet, film, woven fabric and non-woven fabric. Typical substrates used in this invention include, but are not limited to coated and uncoated papers and board made from natural pulp, synthetic pulp or mixtures thereof; natural or synthetic fibers, synthetic or plastic papers, for example those made from polypropylene or polyethylene, paper comprising polymeric fibers; resin or polymeric films or other structures, e.g., card stock, based on polymers such as polypropylene, polyester, polyethylene, polycarbonate, acrylic, polyimide, polyvinyl chloride, polystyrene, cellophane, polyethylene terephthalate, ethylene-vinyl alcoholate, polyacrylonitrile, cellulose acetate butyrate, nylon or polyamide, polyvinyl alcohol, ethylene-vinyl acetate, polyurethane, polymethyl methacrylate, polylactic acid and polycaprolactone; latex impregnated papers; non-woven fabric made from pulp synthetic resin, biodegradable plastic resin or the like; biodegradable plastic film made from aliphatic polyester resin, starch or the like; and woven fabric made of natural or synthetic fibers. Further typical substrates include the commercial products Kevlar®, Nomex®, Tedlar®, Teflon® and Tyvek® (products and trademarks of E.I. DuPont).

Collectively, the film or carrier film, coating or breakaway coating, and metal layer(s) may be referred to as the transfer mechanism or transfer film.

As used in this specification, the phrases “non-selective metallization,” non-selectively metallized,” and the like, including use of the phrase “total transfer” in connection with the transfer of a metallized layer to a substrate, shall be construed to include those processes and the resulting structure, where a transfer mechanism, e.g., a transfer film, is utilized to transfer metal (and its associated coating) from a film to a substrate in a contiguous manner, such that the entire, or substantially the entire, metallic surface of the film transfers to the substrate. In such circumstances, it is to be understood that, while the entire metallic surface may be transferred, it is not necessary that the entire substrate be covered with the transferred metal layer and coating. For purposes of the present invention, the term “substantially” as applied to any criteria, such as a property, characteristic or variable, means to meet the stated criteria in such measure such that one skilled in the art would understand that the benefit to be achieved or condition desired is met. Likewise, as used herein, the phrases “selective metallization”, “selectively metallized,” and the like, shall be mean those processes where a transfer mechanism is utilized to transfer metal from a film to a substrate in a non-contiguous manner, such that less than the entire metallic surface of the carrier film transfers to the substrate. Frequently, in a selective transfer process, and the structure resulting therefrom, at least one metallized area is separated from at least one other metallized area by a non-metallized area. Alternatively, a substantially contiguous area of metal can be transferred to a substrate wherein the transferred metal represents a portion of the total metal area available on the carrier film. In selective transfer, after transfer of metal from the metal-containing layer, the carrier film can include a not insubstantial amount of metal that has not been transferred. In contrast, when total transfer occurs, typically all or substantially all, and often, all of the metal present on the carrier film is transferred. The amount of metal coverage on a given substrate shall have no bearing on whether the substrate is considered to be non-selectively metallized or selectively metallized. For example, an application where a 2-inch wide transfer mechanism transfers a 2-inch wide contiguous stripe on a substrate greater than 2-inches wide is non-selective metallization because the entire metal surface of the transfer mechanism is transferred. Typically, selective metallization refers to a process where images, text, designs, logos or the like are transferred from the transfer mechanism or carrier film to the substrate.

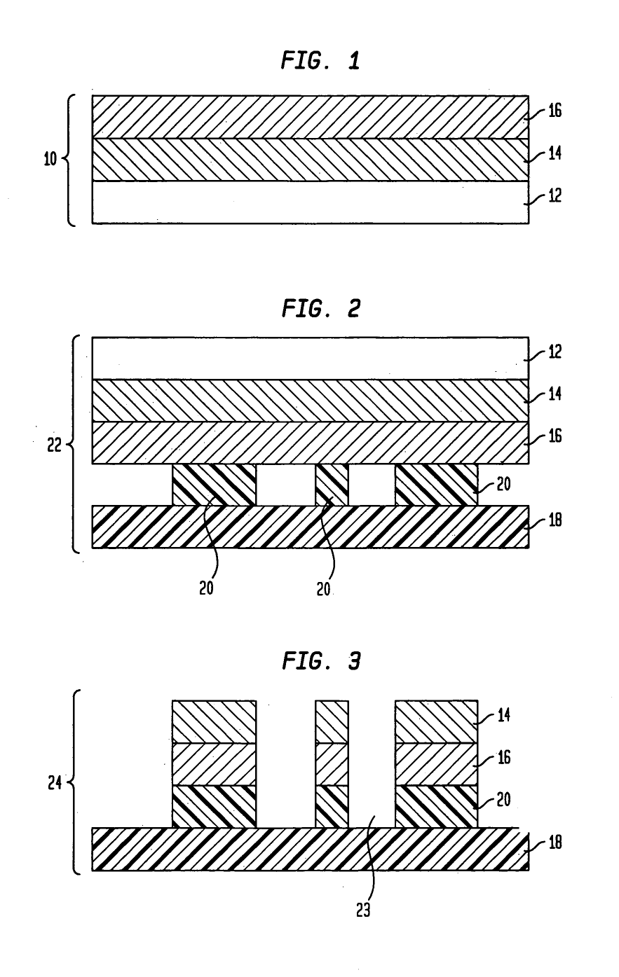

Referring now to the figures, FIG. 1, in accordance with a preferred embodiment of the present invention, depicts a fully coated transfer film 10. The transfer film 10 comprises a carrier film 12 and a metal layer 16 with a breakaway coating 14 positioned therebetween.

The process of creating this transfer film 10 begins by providing the first element, the carrier film 12. As previously discussed, the film comprises a thin flexible sheet of material known in the art. An uncured breakaway coating 14 is applied to the film 12 using processes such as UV offset printing, conventional offset printing, gravure and flexo printing, offset gravure, silk screen printing, air knife, metering rod, and roll coating, according to methods generally known in the industry. While the coating is described as at least one layer or a single layer, it is to be understood that the coating 14 may be comprised of several layers, either of the same material or of different materials working together to form a single, or integrated, coating layer, such as a mixture, or multiple layers applied sequentially. The coating 14 is then cured. Curing of the coating is typically carried out according to methods known in the art, including oven drying and chemical crosslinking, using, e.g., infrared heating, high and low velocity heated air, etc. Alternatively, and where the coating is susceptible to radiation curing as a consequence of its chemical composition, it can be cured using an EB curing process as described earlier and using equipment and conditions known in the art for such processes. In a preferred embodiment, the breakaway coating has a cured elongation at break when tested in tension of less than about 20%.

Metal 16 is deposited, preferably onto the cured coating 14, using known processes such as vacuum metallization or vapor deposition to a thickness suitable for the desired application. At this stage, the transfer film 10 is a relatively stable product, which may be rolled into large diameter rolls (not shown) for future use. If desired, the transfer film 10 can be created in one facility, and transferred to a second facility or second location within the same facility to continue with the remainder of the process of the present invention. In other words, the steps of the process of the present invention need not be carried out in a continuous manner as part of a single operation.

In a second stage of this process, and referring to FIG. 2, a substrate 18 is coated with a transfer adhesive 20. This coating process may be done selectively, so as to create a decorative surface with one or more predetermined, e.g., discontinuous areas, such as a pattern. The transfer adhesive 20 may be applied to the substrate 18 utilizing the techniques previously listed with respect to the coating 14, such as gravure and flexo printing.

For use with porous substrates such as paper or board, the transfer adhesive may be aqueous. Such adhesives are well known in the art. For nonporous substrates such as various biodegradable and non-biodegradable plastics, the preferred transfer adhesive is a 100% solids composition (meaning that an inert diluent or solvent such as a volatile organic compound, is not used) and is radiation curable, e.g., EB curable. The 100% solids adhesive may also be utilized with porous substrates, for example, particularly when metallizing a substrate selectively. Typically, a higher viscosity adhesive is used in connection with porous substrates. In selective metallization, a 100% solids adhesive is preferred as the transition line between metallized areas and nonmetallized areas appears more distinct, precise or sharp than can be achieved with aqueous or diluent-containing adhesives.

Following application of the transfer adhesive 20, the transfer film 10 is placed in contact with the substrate/transfer adhesive element, with the metal layer 16 of the transfer film 10 adjacent the transfer adhesive 20 to form an intermediate product 22 having a structure comprising substrate/adhesive/metal/coating/film, as shown in FIG. 2. Consequently, the “transfer film” is secured to the substrate by means of the transfer adhesive, and, preferably with the application of pressure.

The intermediate product 22 is then exposed to radiation curing, e.g., by being placed in or passed through an EB curing device, to rapidly cure the transfer adhesive 20. As noted previously, EB radiation is capable of very rapid cures at moderate temperatures; typically, about 0.8 seconds to about 10 seconds; preferably about 1 second to about 4.8 seconds; more preferably about 1.2 seconds to about 3.2 seconds. The film 12 is then removed from the intermediate product 22 to reveal the finished product 24, depicted in FIG. 3.

It will be appreciated that in areas where the transfer adhesive 20 is applied, the metal 16 and coating 14 adhere to the substrate 18, and are removed from the film 12. In the void areas 23, the coating 14 and metal 16 remain adhered to the film 12, and are either discarded therewith or reused in a subsequent process. In such a structure, the breakaway coating, metallized area and selectively applied adhesive are in substantial registration; i.e., aligned with one another so as to produce one or more sharp or precise edges. Alternatively, substantially the entire surface of the substrate 18 may be coated with the transfer adhesive 20 such that it will be metallized in its entirety, rather than selectively, if so desired. If the entire surface is coated, there will be no void areas 23.

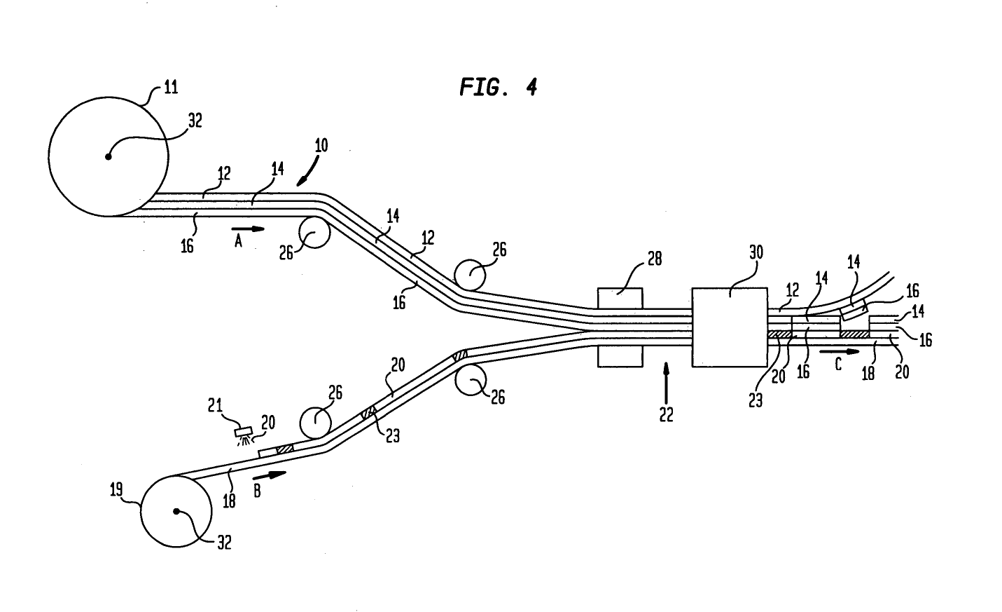

FIG. 4 depicts a schematic view of a preferred process for selectively metallizing a substrate 18. In this preferred process, the transfer film 10 is provided on a transfer film roll 11, with the coating 14 already cured and adhered to metal 16. The transfer film 10 is unrolled from the transfer film roll 11 by a motor 32 in the direction indicated by arrow A.

Concurrently, the substrate 18 is unrolled from a substrate roll 19 by a motor 32 in the direction indicted by arrow B. As the substrate 18 is unrolled, an electron beam curable transfer adhesive 20 is, e.g., selectively applied by an applicator 21, to form areas of curable transfer adhesive interposed with void areas 23.

The transfer film 10 and the substrate 18 with selectively applied transfer adhesive 20 may pass through a series of change of direction pulleys or rollers 26, until they are brought together in a pressure chamber or applicator 28. The pressure chamber preferably applies a sufficient force to place the transfer film 10 and the substrate 18 with selectively applied transfer adhesive 20 into a position adjacent to, and in contact with, each other, to form an intermediate product 22.

The intermediate product 22 is then exposed to EB radiation, e.g., by passing through an electron beam curing apparatus 30 to cure the transfer adhesive 20. Typically, following the electron beam curing apparatus 30, there may also be a mechanism to disengage the film 12 from the remainder of the intermediate product 22. In areas where transfer adhesive 20 has been applied and cured, the film 12 is removed without the coating 14 adhering to it. In the void areas 23, the film 12 is removed with the coating 14 and the metal layer 12 still adhered. Thus, the substrate 18 is selectively metallized. The substrate may then be rolled into a finished product roll (not shown) or cut into sheets (not shown) as desired.

In an alternative embodiment, the transfer adhesive 20 may be applied directly to the metal layer 16 of the transfer film 10 by the applicator 21 in order to form the intermediate product 22.

The coatings and adhesives utilized in preferred and alternative embodiments of this invention include substantially 100% active liquids (i.e., solvent or diluent is substantially absent); such materials are typically referred to as 100% solids since, after curing, the amount of solid material is substantially the same as the amount of liquid material at the start. Preferably the transfer adhesive is EB curable and, alternatively, the breakaway coating can also be EB curable. A radiation curing process such as EB curing has the advantages of, e.g., speed and the avoidance of volatile materials.

Specifically with regard to EB curable adhesives, the lack of out-gassing during and following curing permits the use of substrates which otherwise would be unavailable or more difficult to process using non-EB curable adhesives. For example, substrates used with non-EB curable adhesives are preferably porous in order to permit out-gassing of solvent(s) and/or diluent(s). With EB curable adhesives, nonporous substrates, such as plastics, may be utilized.

With regard to coatings, the lack of out-gassing when EB is used can reduce pitting of the coating upon curing. Such pitting is undesirable as it creates small imperfections across the surface and within the coating, potentially affecting the smoothness, brightness and scuff resistance of the finished product, among other characteristics. Furthermore, an imperfection in an internal region of the coating may make it susceptible to fracture in a place other than the one intended when film is removed, thereby reducing the accuracy of the edges in the metallized areas, particularly in a selectively metallized structure.

Another advantage of EB curable adhesives over non-EB curable adhesives is that non-EB curable adhesives typically must be heated to be cured. Thermal curing typically requires temperatures in the range of about 100° F. to about 500° F.; alternatively, about 250° F. to about 350° F. In contrast, EB curable adhesives may be cured at ambient temperature, typically about 60° F. to about 90° F.; alternatively, about 65° F. to about 80° F., without the need to introduce a heat source. Because EB curable adhesives do not require elevated temperatures to cure, substrates that are susceptible damage due to heat, such as by softening or even melting, may be utilized in the present process where they may not have been suitable for use in processes requiring elevated temperatures, e.g., the use of thin gauge plastics, such as polyvinylchloride (PVC). The use of EB curing also provides the opportunity for other cost savings, e.g., relating to faster and more uniform curing, lower coating weights, etc.

Although EB curing may begin at ambient temperature, it is understood that a moderate heat build-up may occur due to the chemical reactions associated with curing and the energy input associated with the EB equipment. This heat build-up is typically on the order of a few degrees Fahrenheit, but may reach ten or more degrees depending on the thickness of the adhesive layer, the surface area being cured and the composition and thickness of the overall layered structure. It is also to be understood that the level of EB energy required for EB curing of a particular adhesive composition may vary. Useful levels of radiation doses are typically about 1 to about 6 megarads; alternatively, about 3 to about 6 megarads may be utilized. The dosing level typically depends on, and it is known how to adjust for, the particular adhesive being utilized, as well as its thickness and the surface area being covered, and the film and metal deposition thicknesses.

Furthermore, it may be possible to apply EB curable coatings and adhesives in thinner layers. In the present invention, the thickness of a breakaway coating layer is typically about 0.5 microns to about 10 microns; preferably about 1.0 microns to about 7 microns. Similarly, the thickness of the transfer adhesive is typically about 2 microns to about 20 microns; preferably about 4 microns to about 14 microns. Although additional materials or layers are placed above the at least one adhesive layer in the finished product, its thin, uniform cross-section contributes to the relatively smooth and/or desired surface finish of the final product; e.g., where the surface intentionally includes ridges, a holographic pattern, etc. It will be appreciated that in this regard, as well as with respect to other features of the invention, subsequently laid-down surfaces develop attributes based in part on the surfaces upon which they are applied. Thus, a thin, smooth adhesive layer surface will contribute to the metal layer surface also being smooth.

The thinness of the coating and adhesive layers can also contribute to the ability of the finished product to flex. For example, while cracking can occur on a score line in a paper substrate metallized using non-EB curable adhesives, the use of EB curable adhesives and, optionally, coatings, can help to avoid such cracking Consequently, the finished product can be bent, folded, or otherwise manipulated with only negligible degradation in appearance, strength or other condition of the structure.

Another advantage of the process and product of the present invention, including using EB curable adhesives and, optionally, EB curable coatings, is that the finished product surface is hard and scuff resistant. The level of hardness of the product on the Sward Hardness scale is typically about 25 to about 75; preferably, about 35 to about 65; for example, about 50. Alternatively, it is about 50 to about 105; for example, about 100 on the Konig Hardness scale. Scuff resistances can be measured using various test methods. For example, products of the present invention tested for scuff resistance using the Sutherland Rub Tester typically give results of about 50 to about 150 rubs face-to-face; for example about 100 rubs face-to-face using a 4 lb. weight. Alternatively, tests using the Taber Abraider Tester typically result in a weight loss of about 0.1% to about 2.0%, based on the total weight of the sample.

The ability to apply thin layers also provides benefits relating to the application speed or operating speed of a production line. In a typical process using non-EB curable adhesives and/or coatings utilizing substrates provided in rolls, application speeds of up to about 600 feet per minute may be realized. Because of the nature of the EB curable adhesives and coatings, application speeds of about 800 to about 1500 feet per minute may be achieved. Additionally, thinner layers can provide acceptable overall diameters for standard size rolls of intermediate and/or final products, e.g., nominally 72 inches, or the use of larger diameter rolled products on existing equipment with the concomitant advantage of fewer process interruptions.

Where substrates are metallized selectively using conventional or prior art methods, rippling may occur in the roll following the selective metallization process. Such rippling can be caused by localized areas across the width of the roll of greater diameter adjacent to non-built-up areas, which have not been metallized; thinner layers can mitigate such an effect.

Similar advantages may be achieved when the intermediate or final products are stacked in sheets on a skid, rather than rolled. In conventional processes, the thicker metallized areas of the sheets can cause a stack to be non-uniform to the point of instability, or require that the number of stacked sheets be reduced. With sheets metallized in accordance with the present invention, the additional thickness of the metallized portions is sufficiently nominal compared to the non-metallized portions such that the stack can remain generally uniform and stable, up to and including, within commercial tolerances, heights utilized in the industry for sheets or substrates prior to metallization.

The thinness and uniformity of the transfer adhesive layer, particularly the preferred EB curable transfer adhesive, and the use of a breakaway coating layer having the preferred properties expressed hereinabove, permit selective metallization with particularly straight, precise or sharp edges between metallized and adjoining non-metallized areas, two adjoining metallized areas with a non-metallized area between, or at the edges of a substantially totally metallized construction or wherein total transfer of metal has been carried out. In selective metallization using non-EB curable adhesives, and coatings that do not fracture to produce a fine line or precise edge, but, instead, elongate, the line or edge differentiating the metallized areas from the non-metallized areas is not as sharp, precise or distinct as in the present invention. For example, applying the methods of the present invention, the edges of adjoining selectively metallized areas can be produced wherein the distance, in inches, between the adjoining edges of such areas typically differs by less than or equal to about ±0.010; preferably less than or equal to about ±0.008; more preferably less than or equal to about ±0.006; even more preferably less than or equal to about ±0.004; most preferably less than or equal to about ±0.002; for example, less than or equal to ±0.001. In a substantially totally metallized structure, or where total transfer of metal has taken place, these same values apply to the straightness, sharpness or preciseness of an edge of the metallized area. In other words, an edge produced using the methods of the present invention will vary from an unwavering line drawn along an edge and approximately mid-way through the variations by the amounts expressed above. For applications where high quality and precise or sharp, distinct lines or areas are of concern, EB curable adhesives and the breakaway coatings of the present invention are particularly advantageous. They are also advantageous in processes where selectively metallized areas are to be printed. In such instances, accurate registration of the printing with the metallized portions is essential. With distinct, precise or sharp lines between metallized and non-metallized areas, as well as metallized areas having sharply or precisely defined boundaries, as defined above, such registration can be more readily achieved. Additionally, registration of the metal-containing portions of the metal layer and the breakaway coating are also improved significantly in the present invention. Various methods are suitable for printing the surface of the metallized structure, including where printed matter is applied by a method selected from the group consisting of offset, rotogravure, flexographic, letterpress and silk screen.

Furthermore with regard to printing, and wherein an EB curable breakaway layer is used, the clarity and brightness of the underlying metal layer is less susceptible to degradation by the curing process and the thickness of the cured layer. Additionally, in the absence of solvents or diluents, there are fewer extraneous materials to interfere with the properties and uniformity of the breakaway layer or to introduce irregularities for the diffraction of light.

Other properties of the structures produced by the methods of the present invention have been measured and are indicative of a preferred product. For example, where the surface of the metallized structure is to be printed or glued, such as in forming a container, the surface energy of a surface must be suitable for the surface tension of liquids such as adhesives and inks applied to the surface of the finished product; this is particularly so at the exposed surface of the breakaway coating. This characteristic is frequently referred to as the “dyne level” of the surface, although the term used in ASTM D 2578, a test method for measuring this characteristic, is “wetting tension.” The terms are used to represent relative receptivity of a film surface to the addition of inks, coatings, and adhesives. Wetting tension is described as the maximum liquid surface tension that will spread, rather than bead up, on the film surface. It is a measurable property that estimates the surface energy of a film surface. ASTM D 2578 provides a method for determining wetting tension by applying different test solutions of increasing surface tension values until one is found that just spreads or wets the film surface; values are expressed in dynes/cm. The ASTM method is directed to polyethylene and polypropylene films, but the same testing approach can be applied to another film or coated film surface of interest. For example, FINAT FTM 15, an alternative, but similar testing approach is used for plastic films including polyethylene, polypropylene, polyester and polyvinylchloride using test fluids suited to the material under test. (Test methods ASTM D 2578 and FTM 15 incorporated herein by reference; ASTM International, West Conshohocken, Pa., USA; and FINAT, The Hague, The Netherlands) For purposes of the present invention, the dyne level is typically in the range of about 32 to about 58 dynes/cm; preferably about 34 to about 58 dynes/cm; more preferably about 36 to about 58 dynes/cm; most preferably about 36 to about 56 dynes/cm.

Finished product made in accordance with the present invention and tested in an Atlas Fadeometer test typically exhibits acceptable levels of discoloration after about 40 to about 60 hours; preferably, there is no discernible color change, by eye, after 48 hours of exposure. Similarly, finished product in accordance with the present invention tested in a Weatherometer instrument according to standard test methods appropriate for the use of the particular product, e.g., about 80 to about 100 hours, exhibits less than about 10% loss in functionality of the relevant property. For example, properties that may be considered relevant depending on the application include gloss, adhesion, tensile strength, etc.

Also among the advantages of the present invention is the adhesive bond strength achieved between the layers. The typical failure mode observed is between the metal layer and the underlying transfer adhesive layer; less commonly there can be adhesive bond failure between the transfer adhesive and the underlying substrate. Adhesive strength is measured using a hand test and #600, 3M brand Scotch tape applied to the sample surface and pulled away at a rate of approximately 1 ft./min. Where the bond failure occurs between the metal and the transfer adhesive, the material pulled away comprises the metal and breakaway layers and, if used, a prime coat that would be applied between the metal and breakaway layers. If the less common bond failure occurs between the transfer adhesive and the substrate, the material pulled away would also include the weight of the transfer adhesive removed. Products of the present invention typically exhibit the loss of less than about 2 wt. % of material; preferably less than about 1 wt. %; more preferably less than about 0.5 wt. %; for example, no loss. Such performance is particularly important as the layers tend not to delaminate, even after repeated uses, including bending.

The stability of the finished structure, particularly its ability to withstand delamination, and the thinness of the finished product is especially advantageous when the technology is used in the manufacture of credit cards. For purposes of the present invention, the term “credit card” is used in the generic sense and includes cards such as credit, debit, automatic teller machine (ATM), identification, driver's license, security pass cards, etc. Such cards are typically about 5.4 cm wide by about 8.6 cm long. Credit cards are typically held to a thickness of about 30 mm or less to provide uniform operation in the various slide mechanisms or card swipe devices used commercially, e.g., point-of-purchase devices, ATM machines, etc. Conventional metallization processes can add unwanted thickness to the credit card, resulting in the need to use a thinner card-stock material in order not to exceed the 30 mm industry maximum. Utilizing the metallization method of the present invention, credit cards may be formed using thicker stock materials than previously achievable, thus adding to their strength and durability. In addition, the development of high levels of adhesion between the various layers of the overall structure as well as the ability to use a thicker card-stock or substrate can also help to avoid problems of curling due to the presence of layers having dissimilar properties, e.g., thermal expansion rates.

Furthermore, the ability to produce a structure having high levels of adhesion between the various layers, allows the resulting product to be used in flexible packaging, where delamination can be a significant problem. For example, one potential use of a product in accordance with the present invention is for toothpaste tubes, or containers. Presently, toothpaste manufacturers market toothpaste in squeezable tubes that generally are not metallized even though the boxes in which they are packaged and sold are often metallized. The ability to metallized the tube and box in the same manner may provide a potential marketing advantage.

The present invention is capable of producing the above-described structures having higher gloss, better scuff resistance and better adhesion that typical products of the prior art. Generally the products are more esthetically pleasing and display a preferred combination of properties compared to those of the prior art, even though such prior art products may have acceptable properties in one or another test.

The products of the present invention can be used in a wide variety of applications. The structure can be used to manufacture credit cards, bankcards, phone cards, licenses; or to prepare articles of manufacture such as containers, wrapping materials, displays, and signs. Containers can be made for use with a wide variety of products, including foods, cosmetics, drugs, smoking products, toys, electronics, kitchen utensils, glassware, hardware, sporting goods, wearable items, and bottled goods.

### EXAMPLE

A metallized structure of the present invention, made according to a process, e.g., as illustrated in FIG. 2, is manufactured in the following manner. A 0.5 mil clear polyester transfer film is coated on one side by a gravure applicator using a 180 quad engraved cylinder, with aromatic urethane acrylate copolymer having a 70/30 weight ratio of urethane to acrylate components (Grancoat® 571) to a thickness of 3 microns. The breakaway coating is oven dried at 250° F. in a gas fired, hot air, low velocity oven. The dried coating layer has an elongation at break when tested in tension of 0.7%. The coated film is metallized on the coated side in a conventional vacuum metallizer to an optical density of 2.0 on the coated side of the film. The coated, metallized film is transported to an Intraroto® brand laminator equipped with an Energy Sciences Incorporated EZ Cure® brand electron beam (EB) unit. The coated film is laminated on the coated metallized side to a 6 mil white polystyrene plastic substrate, both film and substrate being in web or roll form. An EB curable adhesive (Sun Chemical #7573) is applied in the laminator to one surface of the polystyrene substrate by means of a flexographic printing head using a 200 analox roll (engraved cylinder) engraved to print 4 in. wide stripes separated by 2 in. wide adhesive-free stripes. Both the transfer coated polyester film and the polystyrene substrate are 40 inches wide overall, resulting in an overall product having seven, 4 inch wide, coated strips and six, 2 inch wide, uncoated strips. The EB adhesive is applied to provide a 4 micron thick layer.

The EB cure cycle is set at 125 KV and 4.5 megarads. The lamination process is conducted at 400 feet per minute, effecting a cure time of 1.2 seconds. Within approximately 10 seconds following EB cure, the polyester film is peeled way from the composite, including the polystyrene substrate; the film comes off clean, leaving the urethane acrylate coating and metal firmly attached to only those 4 inch wide stripes to which the EB adhesive has been applied. The metallized areas of the polyester carrier film corresponding to the 2 inch wide stripes to which no EB adhesive is applied, remain attached to the removed polyester film. In those areas where the metal layer is firmly attached to the substrate, the configuration of the layers is: urethane acrylate breakaway layer/metal layer/cured EB adhesive layer/polystyrene substrate. The bond strength between the various layers of the composite structure is capable of withstanding most methods of commercial fabrication in various end uses. The finished metal-striped product is ready for use or further conversion or fabrication in various end-uses, such as boxes, displays, trading cards, etc.

Any range of numbers recited in the specification, paragraphs hereinafter, or claims, describing various aspects of the invention, such as that representing a particular set of properties, units of measure, conditions, physical states or percentages, is intended literally to incorporate expressly herein by reference or otherwise, any number falling within such range, including any subset of numbers or ranges subsumed within any range so recited. Additionally, the term “about” when used as a modifier for, or in conjunction with, a variable, is intended to convey that the values and ranges disclosed herein are flexible and that practice of the present invention by those skilled in the art using, e.g., temperatures, concentrations, amounts, contents, carbon numbers, properties such as elongation, hardness, surface tension, viscosity, particle size, surface area, solubility, etc., that are outside of the stated range or different from a single value, will achieve the desired result, namely, preparation of a metallized substrate having an improved appearance in the metallized portions and comprising a layered structure, methods of forming such a metallized substrate, and metallized articles produced thereby.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A layered structure comprising at least one each of: (a) a substrate layer; (b) a metal-containing layer; (c) an adhesive-containing layer adhering said metal in said metal-containing layer to said substrate layer; and (d) a breakaway layer, having a top surface and a bottom surface, said bottom surface of said breakaway layer coating substantially only said metal of said metal-containing layer, and said breakaway layer having a cured elongation at break when tested in tension of less than about 20%.

2. The structure of claim 1 wherein said metal-containing layer comprises a metal selected from the group consisting of gold; platinum; silver; aluminum; zinc; copper; nickel; tin; silicon; and alloys and mixtures thereof.

3. The structure of claim 1 wherein the metal in said metal-containing layer has a thickness selected from the group consisting of about 20 Å to about 1000 Å; about 30 Å to about 800 Å; about 40 Å to about 600 Å; about 50 Å to about 400 Å; about 55 Å to about 300 Å; and about 60 Å to about 200 Å.

4. The structure of claim 1 wherein the metal in said metal-containing layer has a thickness of about 25 Å to about 150 Å.

5. The structure of claim 1 wherein said substrate layer comprises a polymer selected from the group consisting of paper made from natural pulp, synthetic pulp or mixtures thereof; polypropylene; polyethylene; polyester; polycarbonate; acrylic; polyimide; polyvinylchloride; polystyrene; cellophane; polyethylene terephthalate; ethylene vinylacetate copolymer; ethylene vinylalcohol; polyacrylonitrile; cellulose acetate butyrate; polyamide; polyvinylalcohol; polyalanide; polyimide; polyurethane; polymethylmethacrylate; polylactic acid; polycaprolactone; Kevlar; Nomex; Tedlar; Teflon; Tyvek; and mixtures thereof.

6. The structure of claim 5 wherein said substrate layer is in a form selected from the group consisting of board, sheet, film, woven fabric and non-woven fabric.

7. The structure of claim 5 wherein said substrate layer further comprises at least one additive selected from the group consisting of fillers, dyes and pigments.

8. The structure of claim 1 wherein said adhesive comprises at least one component selected from the group consisting of urethane acrylate resin; epoxy acrylate resin; polyester acrylate resin; mono- di-, tri-, or tetra-hexacrylate resin; and mixtures thereof.

9. The structure of claim 8 wherein said adhesive further comprises at least one additive selected from the group consisting of fillers, dyes and pigments.

10. The structure of claim 1 wherein said adhesive-containing layer is cured by electron beam radiation.

11. The structure of claim 1 wherein said breakaway layer comprises at least one cured oligomer or polymer component selected from the group consisting of acrylates; urethane acrylates; epoxy acrylates; polyester acrylates; mono- di-, tri-, or tetra-hexacrylate; acrylate acrylics aliphatic polyurethanes; aromatic polyurethanes; polyesters; cellulose derivatives; cellulose acetate; cellulose acetate butyrate; nitrocellulose; acrylics; and mixtures thereof.

12. The structure of claim 11 wherein said breakaway layer further comprises at least one additive selected from the group consisting of fillers, dyes and pigments.

13. The structure of claim 1 wherein said top surface of said breakaway layer includes a surface finish selected from the group consisting of a mirror finish; a matte finish; a hairline pattern finish; an embossed pattern finish; a hologram pattern finish; and mixtures thereof.

14. The structure of claim 1 including printed matter disposed on said top surface of said breakaway layer.

15. The structure of claim 14 wherein said printed matter is applied by a method selected from the group consisting of offset, rotogravure, flexographic, letterpress and silk screen.

16. A method of metallizing a substrate comprising the steps of:
(a) providing a transfer film comprising a film layer and a metal layer bonded together by a cured breakaway layer, said breakaway layer having a cured elongation at break when tested in tension of less than about 20%;
(b) providing a substrate;
(c) applying an electron beam curable transfer adhesive to at least a portion of said substrate;
(d) securing said transfer film to said substrate comprising said transfer adhesive such that said transfer adhesive is disposed between said metal layer and said substrate to form an intermediate product;
(e) passing said intermediate product through an electron beam curing apparatus to cure said transfer adhesive;
(f) removing said transfer film from said intermediate product to provide a metallized substrate product.

17. The method of claim 16, including applying said transfer adhesive selectively to only portions of said substrate, whereby said metallized substrate product includes metal-containing portions in said metal layer and said breakaway coating layer bonded thereto only in said portions of said substrate.

18. The method of claim 16, wherein said substrate is selected from the group consisting of paper made from natural pulp, synthetic pulp or mixtures thereof; polypropylene; polyethylene; polyester; polycarbonate; acrylic; polyimide; polyvinylchloride; polystyrene; cellophane; polyethylene terephthalate; ethylene vinylacetate copolymer; ethylene vinylalcohol; polyacrylonitrile; cellulose acetate butyrate; polyamide; polyvinylalcohol; polyalanide; polyimide; polyurethane; polymethylmethacrylate; polylactic acid; polycaprolactone; Kevlar; Nomex; Tedlar; Teflon; Tyvek; and mixtures thereof.

19. The method of claim 16, wherein said substrate comprises credit card stock.

20. The method of claim 16 including using said metallized substrate product to prepare an article of manufacture selected from the group consisting of credit cards, bankcards, phone cards, trading cards, licenses, containers, wrapping materials, displays, and signs.

21. The method of claim 20 including using said metallized substrate product to prepare said container for use with a product selected from the group consisting of foods, cosmetics, drugs, smoking products, toys, electronics, kitchen utensils, glassware, hardware, sporting goods, wearable items, and bottled goods.

22. The method of claim 16, including applying said electron beam curable adhesive substantially free of water or non-curable volatile organic solvents or diluents.

23. The method of claim 16, including applying said transfer adhesive to selective areas of said substrate.

24. The method of claim 16 wherein said breakaway coating is cured by a method selected from the group consisting of radiation or thermal energy.

25. The method of claim 24 including curing said breakaway coating by electron beam radiation.

26. The method of claim 24 including curing said breakaway coating by thermal energy.

27. The method of claim 16 including providing a transfer film having a metal layer having an optical density of greater than about 1.5.

28. The structure of claim 1, having a scuff resistance of about 50 to about 150 rubs face to face as measured using a 4 lb. weight utilizing the Sutherland Rub Tester.

29. The structure of claim 1, having has a scuff resistance of about 0.1% to about 2.0% weight loss, based on the total sample weight, using the Taber Abraider Tester.

30. The structure of claim 1, having a hardness of about 25 to about 75 on the Sward Hardness scale.

31. The structure of claim 1, having a hardness of about 50 to about 105 on the Konig Hardness Scale.

32. The structure of claim 1, having a bond strength such that less than about wt. 2% of the top surface of said finished product is removed following adhesive contact with No. 600, 3M Scotch brand adhesive tape at an extension rate of about 1 ft./min.

33. The structure of claim 1, wherein said top surface of said breakaway coating has a dyne level of about 32 to about 58 dynes/cm.

34. The structure of claim 1, exhibiting acceptable discoloration after about 40 to about 60 hours exposure in an Atlas Fadeometer test.

35. The structure of claim 1, exhibiting less than about 10% loss in functionality after exposure in a Weatherometer test for about 80 hours.

36. A method of selectively metallizing a substrate comprising the steps of:
(a) providing a transfer film comprising a film layer and a metal layer bonded together by a breakaway layer, said breakaway layer having a cured elongation at break when tested in tension of less than about 20%;
(b) providing a substrate;
(c) applying an electron beam curable transfer adhesive to selective areas of said substrate in order to form a selective adhesive layer;
(d) securing said transfer film to said substrate such that said transfer adhesive is between said metal layer and said substrate thereby forming an intermediate product;
(e) exposing said intermediate product to electron beam radiation to substantially cure said transfer adhesive; and
(f) removing said film layer from said intermediate product to provide a selectively metallized substrate product wherein said metal and said breakaway layer bonded thereto, and said selectively applied transfer adhesive layer are in substantial registration.

37. The method of claim 36 including curing said breakaway coating by a method selected from the group consisting of radiation or thermal energy.

38. The method of claim 37 including curing said breakaway coating by electron beam radiation.

39. The method of claim 37 including curing said breakaway coating by thermal energy.

40. The method of claim 36 including providing a transfer film having a metal layer having an optical density of greater than about 1.5.

41. A method of metallizing a substrate to provide precisely metallized edges comprising the steps of:
(a) providing a transfer film comprising a film layer and a metal layer bonded together by a breakaway layer, said breakaway layer having a cured elongation at break when tested in tension of less than about 20%;
(b) providing a substrate;
(c) applying an electron beam curable transfer adhesive to at least a portion of said substrate wherein said portion includes at least one edge;
(d) securing said transfer film to said substrate comprising said transfer adhesive such that said transfer adhesive is disposed between said metal layer and said substrate to form an intermediate product;
(e) exposing said intermediate product to electron beam radiation to substantially cure said transfer adhesive;
(f) removing said transfer film from said intermediate product to provide a metallized product having at least one metallized edge, said metallized edge varying from a line drawn along said edge and mid-way through the variations from said line by less than or equal to about ±0.010 inches.

42. The method of claim 41 wherein said variation is less than or equal to about ±0.0010 inches.

43. A method of selectively metallizing a substrate to provide sharply or precisely metallized edges comprising the steps of:
(a) providing a transfer film comprising a film layer and a metal layer bonded together by a breakaway layer, said breakaway layer having a cured elongation at break when tested in tension of less than about 20%;
(b) providing a substrate;
(c) applying an electron beam curable transfer adhesive selectively to at least two areas of said substrate in order to form a selective adhesive layer;
(d) securing said transfer film to said substrate such that said transfer adhesive is between said metal layer and said substrate thereby forming an intermediate product;
(e) exposing said intermediate product to electron beam radiation to substantially cure said transfer adhesive; and
(f) removing said film layer from said intermediate product to provide a metallized product having at least two selectively metallized areas, each said area comprising at least one metallized edge, said edges separated from one another by a non-metallized area, the distance between adjoining edges of said selectively metallized areas differing by less than or equal to about ±0.010 inches.

44. The method of claim 43 wherein said difference is less than or equal to about ±0.0010 inches.

45. A method for selectively metallizing a polymer-containing substrate comprising:
(a) providing a transfer film from a transfer film roll, wherein said transfer film comprises a film layer and a metal layer bonded together by a breakaway coating layer, wherein said breakaway layer has a cured elongation at break when tested in tension of less than about 20%;
(b) providing a polymer-containing substrate;
(c) selectively applying an electron beam curable transfer adhesive to portions of said substrate in order to form a selective adhesive layer thereon;
(d) bringing into contact said metal layer of said transfer film and said selective adhesive layer of said substrate, thereby forming an intermediate product;
(e) exposing said intermediate product to electron beam radiation to substantially cure said selectively applied transfer adhesive; and,
(f) removing said film layer from said intermediate product to provide a selectively metallized product comprising said metal layer in substantial registration with said selectively applied transfer adhesive.

46. The method of claim 45 including curing said breakaway coating by a method selected from the group consisting of radiation or thermal energy.

47. The method of claim 46 including curing said breakaway coating by electron beam radiation.

48. The method of claim 46 including curing said breakaway coating by thermal energy.

49. The method of claim 45 including providing a transfer film having a metal layer having an optical density of greater than about 1.5.

50. A transfer film comprising a film layer and a metal layer bonded together by a cured breakaway coating layer having a top surface in contact with said transfer film and a bottom surface in contact with said metal layer, wherein said breakaway layer has a cured elongation at break when tested in tension of less than about 20%.

51. The transfer film of claim 50 wherein said film layer comprises a polymer film.

52. The transfer film of claim 51 wherein said metal layer has a thickness of about 30 Å to about 800 Å and comprises a metal selected from the group consisting of gold; platinum; silver; aluminum; zinc; copper; nickel; tin; silicon; and alloys and mixtures thereof.

53. The transfer film of claim 50 wherein said breakaway layer comprises at least one cured oligomer or polymer component selected from the group consisting of acrylates; urethane acrylates; epoxy acrylates; polyester acrylates; mono- di-, tri-, or tetra-hexacrylate; acrylate acrylics aliphatic polyurethanes; aromatic polyurethanes; polyesters; cellulose derivatives; cellulose acetate; cellulose acetate butyrate; nitrocellulose; acrylics; and mixtures thereof.

54. The transfer film of claim 50 wherein said breakaway coating is cured by electron beam radiation.

55. The transfer film of claim 50 wherein said breakaway coating is cured by thermal energy.

56. The transfer film of claim 50 wherein the top surface of said breakaway coating has a dyne level of about 32 to about 58 dynes/cm.

57. The transfer film of claim 50 wherein said metal layer has an optical density of greater than about 1.5.

58. A selectively metallized layered structure comprising at least one each of: (a) a substrate layer; (b) a metal-containing layer comprising selectively metallized portions; (c) an adhesive layer adhering said selectively metallized portions of said metal-containing metal layer to said substrate layer; and (d) a breakaway layer, having a top surface and a bottom surface, said bottom surface of said breakaway layer coating said selectively metallized portions of said metal-containing layer, and said breakaway layer having cured elongation at break when tested in tension of less than about 20%.

59. The selectively metallized layered structure of claim 58 having at least two selectively metallized areas, each said area having at least one metallized edge, said edges separated from one another by a non-metallized area, thereby providing adjoining metallized edges.

60. The selectively metallized layered structure of claim 59 wherein the distance between said adjoining metallized edges varies by less than or equal to about ±0.010 inches.

61. The selectively metallized layered structure of claim 60 wherein said distance varies by less than or equal to about ±0.0010 inches.

62. A layered structure comprising at least one each of: (a) a substrate layer; (b) a metal-containing layer; (c) a radiation curable adhesive layer adhering said metal of said metal-containing layer to said substrate layer; and (d) a radiation curable breakaway layer, having a top surface and a bottom surface, said bottom surface of said breakaway layer coating said metal of said metal-containing layer, and said top surface of said breakaway layer dyne level of about 34 to about 58 dynes/cm.

63. A layered structure comprising at least one each of: (a) a substrate layer; (b) a metal-containing layer; (c) a radiation curable adhesive layer adhering said metal of said metal-containing layer to said substrate layer; and (d) a radiation curable breakaway layer, having a top surface and a bottom surface, said bottom surface of said breakaway layer coating said metal of said metal-containing layer, said breakaway layer having a cured elongation at break when tested in tension of about 100% to about 300%.

64. The layered structure of claim 63 wherein said breakaway layer of about 34 to about 58 dynes/cm.

65. The layered structure of claim 63 wherein said cured elongation is about 100% to about 200%.

66. The layered structure of claim 65 wherein said cured elongation is about 105% to about 175%.

67. A method of metallizing a substrate comprising the steps of:
(a) providing a transfer film comprising a film layer and a metal layer bonded together by a radiation cured breakaway layer, said breakaway layer having a top surface and a bottom surface, said top surface in contact with said film layer;
(b) providing a substrate having a top surface and a bottom surface;
(c) applying an electron beam curable transfer adhesive to substantially all of said substrate top surface;
(d) securing said transfer film to said substrate top surface comprising said transfer adhesive such that said transfer adhesive is disposed between said metal present in said metal layer and said substrate to form an intermediate product;
(e) passing said intermediate product through an electron beam curing apparatus to cure said transfer adhesive;
(f) removing said transfer film from said intermediate product in order to transfer substantially all of said metal present in transfer film so as to provide a metallized product.

68. The method of claim 67 wherein said breakaway layer is cured using electron beam radiation.

69. The method of claim 67 wherein said metal layer has an optical density of greater than about 1.5.

70. The method of claim 67 wherein said metal layer is about 60 Å to about 200 Å.

71. The method of claim 67 wherein said breakaway layer exhibits a dyne level of about 34 to about 58 dynes/cm.

72. A layered structure comprising at least one each of: (a) a substrate layer; (b) a metal-containing layer; (c) an adhesive-containing layer adhering said metal in said metal-containing layer to said substrate layer; and (d) a breakaway layer, having a top surface and a bottom surface, said bottom surface of said breakaway layer coating substantially only said metal of said metal-containing layer.

73. The structure of claim 72 wherein said metal-containing layer comprises a metal selected from the group consisting of gold; platinum; silver; aluminum; zinc; copper; nickel; tin; silicon; and alloys and mixtures thereof.

74. The structure of claim 72 wherein the metal in said metal-containing layer has a thickness of about 30 Å to about 800 Å.

75. The structure of claim 72 wherein the metal in said metal-containing layer has a thickness of about 25 Å to about 150 Å.

76. The structure of claim 72 wherein said substrate layer comprises a polymer selected from the group consisting of paper made from natural pulp, synthetic pulp or mixtures thereof; polypropylene; polyethylene; polyester; polycarbonate; acrylic; polyimide; acrylic; polyimide; polyvinylchloride; polystyrene; cellophane; polyethylene terephthalate; ethylene vinylacetate copolymer; ethylene vinylalcohol; polyacrylonitrile; cellulose acetate butyrate; polyamide; polyvinylalcohol; polyalanide; polyimide; polyurethane; polymethylmethacrylate; polylactic acid; polycaprolactone; Kevlar; Nomex; Tedlar; Teflon; Tyvek; and mixtures thereof.

77. The structure of claim 76 wherein said substrate layer is in a form selected from the group consisting of board, sheet, film, woven fabric and non-woven fabric.

78. The structure of claim 76 wherein said substrate layer further comprises at least one additive selected from the group consisting of fillers, dyes and pigments.

79. The structure of claim 72 wherein said adhesive comprises at least one component selected from the group consisting of urethane acrylate resin; epoxy acrylate resin; polyester acrylate resin; mono- di-, tri-, or tetra-hexacrylate resin; and mixtures thereof.

80. The structure of claim 79 wherein said adhesive further comprises at least one additive selected from the group consisting of fillers, dyes and pigments.

81. The structure of claim 72 wherein the adhesive in said adhesive-containing layer is cured by electron beam radiation.

82. The structure of claim 72 wherein said breakaway layer comprises at least one cured oligomer or polymer component selected from the group consisting of acrylates; urethane acrylates; epoxy acrylates; polyester acrylates; mono- di-, tri-, or tetra-hexacrylate; acrylate acrylics aliphatic polyurethanes; aromatic polyurethanes; polyesters; cellulose derivatives; cellulose acetate; cellulose acetate butyrate; nitrocellulose; acrylics; and mixtures thereof.

83. The structure of claim 82 wherein said breakaway layer further comprises at least one additive selected from the group consisting of fillers, dyes and pigments.

84. The structure of claim 72 wherein said top surface of said breakaway layer includes a surface finish selected from the group consisting of a mirror finish; a matte finish; a hairline pattern finish; an embossed pattern finish; a hologram pattern finish; and mixtures thereof.

85. The structure of claim 72 including printed matter disposed on said top surface of said breakaway layer.

86. The structure of claim 85 wherein said printed matter is applied by a method selected from the group consisting of offset, rotogravure, flexographic, letterpress and silk screen.

87. The structure of claim 72, having a scuff resistance of about 50 to about 150 rubs face to face as measured using a 4 lb. weight utilizing the Sutherland Rub Tester.

88. The structure of claim 72, having has a scuff resistance of about 0.1% to about 2.0% weight loss, based on the total sample weight, using the Taber Abraider Tester.

89. The structure of claim 72, having a hardness of about 25 to about 75 on the Sward Hardness scale.

90. The structure of claim 72, having a hardness of about 50 to about 105 on the Konig Hardness Scale.

91. The structure of claim 72, having a bond strength such that less than about wt. 2% of the top surface of said finished product is removed following adhesive contact with No. 600, 3M Scotch brand adhesive tape at an extension rate of about 1 ft./min.

92. The structure of claim 72, wherein the top surface of said breakaway coating has a dyne level of about 32 to about 58 dynes/cm.

93. The structure of claim 72, exhibiting acceptable discoloration after about 40 to about 60 hours exposure in an Atlas Fadeometer test.

94. The structure of claim 72, exhibiting less than about 10% loss in functionality after exposure in a Weatherometer test for about 80 hours.

95. A selectively metallized layered structure comprising at least one each of: (a) a substrate layer; (b) a metal-containing layer comprising selectively metallized portions; (c) an adhesive layer adhering said selectively metallized portions of said metal-containing metal layer to said substrate layer; and (d) a breakaway layer, having a top surface and a bottom surface, said bottom surface of said breakaway layer coating said selectively metallized portions of said metal-containing layer.

96. The selectively metallized layered structure of claim 95 having at least two selectively metallized portions, each said portion having at least one metallized edge, said edges separated from one another by a non-metallized portion, thereby providing adjoining metallized edges.

97. The selectively metallized layered structure of claim 96 wherein the distance between said adjoining metallized edges varies by less than or equal to about ±0.010 inches.

98. The selectively metallized layered structure of claim 97 wherein said distance varies by less than or equal to about ±0.0010 inches.

99. A layered structure comprising at least one each of: (a) a substrate layer; (b) a metal-containing layer; (c) a radiation curable adhesive layer adhering said metal of said metal-containing layer to said substrate layer; and (d) a radiation curable breakaway layer, having a top surface and a bottom surface, said bottom surface of said breakaway layer coating said metal of said metal-containing layer, and said top surface of said breakaway layer exhibiting a dyne level of about 34 to about 58 dynes/cm.

100. A layered structure comprising at least one each of: (a) a substrate layer; (b) a metal-containing layer; (c) a radiation curable adhesive layer adhering said metal of said metal-containing layer to said substrate layer; and (d) a radiation curable breakaway layer, having a top surface and a bottom surface, said bottom surface of said breakaway layer coating said metal of said metal-containing layer, said breakaway layer having a cured elongation at break when tested in tension of about 100% to about 300%.

101. The structure of claim 100 wherein said breakaway layer exhibits a dyne level of about 34 to about 58 dynes/cm.

102. The structure of claim 100 wherein said cured elongation is about 100% to about 200%.

103. The structure of claim 102 wherein said cured elongation is about 105% to about 175%.

104. The structure of claim 100 wherein the metal in said metal-containing layer has an optical density of greater than about 1.5.

105. A method of metallizing a substrate comprising the steps of:
(a) providing a transfer film comprising a film layer and a metal layer bonded together by a cured breakaway layer;
(b) providing a substrate;
(c) applying an electron beam curable transfer adhesive to at least a portion of said substrate;
(d) securing said transfer film to said substrate comprising said transfer adhesive such that said transfer adhesive is disposed between said metal layer and said substrate to form an intermediate product;
(e) passing said intermediate product through an electron beam curing apparatus to cure said transfer adhesive;
(f) removing said transfer film from said intermediate product to provide a metallized substrate product having a cured breakaway layer bonded to said metal layer at said transfer adhesive portion.

106. The method of claim 105, including applying said transfer adhesive selectively to said substrate.

107. The method of claim 105, wherein said substrate is selected from the group consisting of paper made from natural pulp, synthetic pulp or mixtures thereof; polypropylene; polyethylene; polyester; polycarbonate; acrylic; polyimide; polyvinylchloride; polystyrene; cellophane; polyethylene terephthalate; ethylene vinylacetate copolymer; ethylene vinylalcohol; polyacrylonitrile; cellulose acetate butyrate; polyamide; polyvinylalcohol; polyalanide; polyimide; polyurethane; polymethylmethacrylate; polylactic acid; polycaprolactone; Kevlar; Nomex; Tedlar; Teflon; Tyvek; and mixtures thereof.

108. The method of claim 105, wherein said substrate comprises credit card stock.

109. The method of claim 105 including using said metallized substrate product to prepare an article of manufacture selected from the group consisting of credit cards, bankcards, phone cards, trading cards, licenses, containers, wrapping materials, displays, and signs.

110. The method of claim 109 including using said metallized substrate product to prepare said container for use with a product selected from the group consisting of foods, cosmetics, drugs, smoking products, toys, electronics, kitchen utensils, glassware, hardware, sporting goods, wearable items, and bottled goods.

111. The method of claim 105, including applying said electron beam curable adhesive substantially free of water or non-curable volatile organic solvents or diluents.

112. The method of claim 105 wherein said breakaway coating is cured by a method selected from the group consisting of radiation or thermal energy.

113. The method of claim 112 including curing said breakaway coating by electron beam radiation.

114. The method of claim 112 including curing said breakaway coating by thermal energy.

115. The method of claim 105 including providing a transfer film having a metal layer having an optical density of greater than about 1.5.

116. The method of claim 105 including providing a breakaway layer having a cured elongation at break when tested in tension of less than about 20%.

117. The method of claim 116 wherein said metallized substrate product has at least one metallized edge, said metallized edge varying from a line drawn along said edge and mid-way through the variations from said line by less than or equal to about ±0.010 inches.

118. The method of claim 117 wherein said variation is less than or equal to about ±0.0010 inches.

119. A method of selectively metallizing a substrate comprising the steps of:
(a) providing a transfer film comprising a film layer and a metal layer bonded together by a breakaway layer;
(b) providing a substrate;
(c) applying an electron beam curable transfer adhesive to selective areas of said substrate in order to form a selective adhesive layer;
(d) securing said transfer film to said substrate such that said transfer adhesive is between said metal layer and said substrate thereby forming an intermediate product;
(e) exposing said intermediate product to electron beam radiation to substantially cure said transfer adhesive; and
(f) removing said film layer from said intermediate product to provide a selectively metallized substrate product wherein said metal and said breakaway layer bonded thereto, and said selectively applied cured transfer adhesive layer are in substantial registration.

120. The method of claim 119 including curing said breakaway coating by a method selected from the group consisting of radiation or thermal energy.

121. The method of claim 120 including curing said breakaway coating by electron beam radiation.

122. The method of claim 120 including curing said breakaway coating by thermal energy.

123. The method of claim 119 including providing a transfer film having a metal layer having an optical density of greater than about 1.5.

124. The method of claim 119 including applying said transfer adhesive to at least two areas of said substrate layer.

125. The method of claim 124 to provide a metallized product having at least two selectively metallized areas, each said area comprising at least one metallized edge, said edges separated from one another by a non-metallized area, the distance between adjoining edges of said selectively metallized areas differing by less than or equal to about ±0.010 inches.

126. The method of claim 125 wherein said difference is less than or equal to about ±0.0010 inches.

127. The method of claim 119, wherein said substrate is selected from the group consisting of paper made from natural pulp, synthetic pulp or mixtures thereof; polypropylene; polyethylene; polyester; polycarbonate; acrylic; polyimide; polyvinylchloride; polystyrene; cellophane; polyethylene terephthalate; ethylene vinylacetate copolymer; ethylene vinylalcohol; polyacrylonitrile; cellulose acetate butyrate; polyamide; polyvinylalcohol; polyalanide; polyimide; polyurethane; polymethylmethacrylate; polylactic acid; polycaprolactone; Kevlar; Nomex; Tedlar; Teflon; and Tyvek; mixtures thereof.

128. The method of claim 119, wherein said substrate comprises credit card stock.

129. The method of claim 119 including using said metallized substrate product to prepare an article of manufacture selected from the group consisting of credit cards, bankcards, phone cards, trading cards, licenses, containers, wrapping materials, displays, and signs.

130. The method of claim 129 including using said metallized substrate product to prepare said container for use with a product selected from the group consisting of foods, cosmetics, drugs, smoking products, toys, electronics, kitchen utensils, glassware, hardware, sporting goods, wearable items, and bottled goods.
